(19) United States
(12) Patent Application Publication
(10) Pub. No.: US 2022/0243496 A1
(43) Pub. Date: Aug. 4, 2022

(54) RIGID ROOF TENT

(71) Applicant: Wild Land Outdoor Gear Ltd., Xiamen City (CN)

(72) Inventor: Nanqing Zhou, Xiamen City (CN)

(21) Appl. No.: 17/405,654

(22) Filed: Aug. 18, 2021

(30) Foreign Application Priority Data
Feb. 4, 2021 (CN) 202120322096.9
Jun. 17, 2021 (CN) 202110674955.5

(51) Int. Cl. E04H 15/06; E04H 15/48

(52) U.S. Cl. CPC E04H 15/06; E04H 15/48

(57) ABSTRACT

A rigid roof tent includes a first cover part, a second cover part, a hinge connection part, a folding and fixing part rotatably connected to the two cover parts, and a tent part connected to the two cover parts; one of the two cover parts is configured to be fixedly mounted on a roof of a vehicle, the two cover parts are arranged to face each other when in a tent fold mode; at least one end of the folding and fixing part is in a separate state from the one of the two cover parts when in a tent unfold mode, and one end of the folding and fixing part that is originally in the separate state covering fixedly on a side of one of the two cover parts when in the tent fold mode, so that the two cover parts are fixed when they are folded.

### RELATED APPLICATION

The instant application claims priority to Chinese Patent Applications 202110674955.5, filed Jun. 17, 2021, and 202120322096.9, filed Feb. 4, 2021, which are incorporated herein by reference.

### TECHNICAL FIELD

The present disclosure relates to the technical field of outdoor equipment, and in particular, to a rigid roof tent.

### BACKGROUND

In recent years, with the continuous growth of private car ownership, self-driving travel has become an emerging mode of travel. In order to meet the convenience of people's self-driving travel, the development of products attached to the car for self-driving travel is in the ascendant, and outdoor equipment such as car tents are developed in this environment.

A roof tent is a tent that can be set up on the roof of a car. Since it is not close to the ground like other tents when in use, it is less susceptible to the intrusion of ground air and moisture, and it is more comfortable to use, and is favored by people. The roof tent can be directly folded on the roof when not in use, so it is convenient for transportation.

Roof tents come in various shapes. U.S. Pat. No. 10,808,416 B2 discloses a roof tent, it includes a first cover part, a second cover part, a hinge connection part, a waterproof part and a tent part. The hinge connection part is rotatably connected to the first cover part and the second cover part. Both ends of the waterproof part are fixed on the first cover part and the second cover part. The tent part is connected to the first cover part and the second cover part. One of the first cover part and the second cover part is configured to be fixedly mounted on the roof of the vehicle. This roof tent has a fold mode in which the first cover part and the second cover part are arranged to face each other, and the tent part is received in the space between the first cover part and the second cover part. The roof tent also has an unfold mode in which the tent is unfolded by rotating one of the first cover part and the second cover part relative to the other one around the hinge connection part. The waterproof part is detachably fastened to the edges of the first cover part and the second cover part in the fold mode, to close the space between the first cover part and the second cover part.

After careful analysis of the above-mentioned roof tent, it is found that the waterproof part actually includes: a first waterproof member including a first fastening rod and a tarp extending from the first fastening rod; and a second waterproof member including a second fastening rod and a tarp extending from the second fastening rod. Wherein the first waterproof member and the second waterproof member are detachably fastened to each other along a fastening line formed in each tarp, and wherein the first waterproof member and the second waterproof member are fastened to each other by a fastening wire (such as a zipper), so that tension is applied to each of the first and second tarps, thereby preventing external moisture from penetrating into the tent part.

Therefore, the above-mentioned roof tent has some shortcomings:

1. The two edges of the waterproof part are completely fixed to the edges of the first cover part and the second cover part in the fold mode, and can completely close the space between the first cover part and the second cover part after assembly. In this way, In order to ensure that the first cover part and the second cover part can be opened after the waterproof part is assembled, the waterproof part must adopts the first waterproof member and the second waterproof member to be fastened to each other through a fastening line, that is, the waterproof part is composed of two separate components. It has many components, with inconvenient processing and assembly of components, and the cost is high;

2. The waterproof part adopts the first waterproof member and the second waterproof member to be connected by a fastening line (zipper). When assembling, the flatness of the first and second waterproof member must be ensured to ensure the smooth connection of the fastening line (zipper). The size of the waterproof part is required to be high. If the waterproof part is too narrow, it will be difficult to assemble. The assembled waterproof part is easily damaged due to too tight pulling. It is also inconvenient to assemble if the waterproof part is too wide. The assembled waterproof part will accumulate and hinder the pull of the zipper. The appearance can also be affected. Therefore, the defective rate of the product is relatively high.

3. The first waterproof member includes a first fastening rod and a tarp extending from the first fastening rod; the second waterproof member includes a second fastening rod and a tarp extending from the second fastening rod; each tarp has also a fastening line (zipper). The structure of the first waterproof member and the second waterproof member is complicated, such that the processing is inconvenient and the cost is high;

4. The first waterproof member and the second waterproof member are connected by a fastening line (zipper), and the two members cooperate with each other, and the firmness is poor;

5. Each tarp also has a fastening line (zipper). The fastening line is formed on the tarp. The cost is relatively high. It is prone to failure during use, which affects the waterproof effect and high maintenance cost.

In view of this, the inventors conducted research on this tent structure, and redesigned a rigid roof tent of the present disclosure.

### SUMMARY

The present disclosure is intended to provide a rigid roof tent, to reduce components, structure and cost.

In order to achieve the above objectives, the technical solutions adopted by the present disclosure are as follows:

A rigid roof tent comprises: a first cover part, a second cover part, a hinge connection part, a folding and fixing part and a tent part; the hinge connection part is rotatably connected to the first cover part and the second cover part; the tent part is connected to the first cover part and the second cover part; one of the first cover part and the second cover part is configured to be fixedly mounted on a roof of a vehicle, the first cover part and the second cover part are arranged to face each other when in a tent fold mode; at least one end of the folding and fixing part is in a separate state from the one of the first cover part and the second cover part when in a tent unfold mode, and one end of the folding and fixing part that is originally in the separate state covers fixedly on a side of the first cover part or the second cover part when in the tent fold mode, so that the first cover part and the second cover part are fixed when they are folded.

In the first aspect:

The one end of the folding and fixing part is in the separate state from the one of the first cover part and the second cover part that is set to be fixedly mounted in the vehicle when in the tent unfold mode, another end of the folding and fixing part is in a fix state with another one of the first cover part and the second cover part when in the tent unfold mode;

and when in the tent fold mode, the one end of the folding and fixing part that is originally in the separate state covers the one of the first cover part and the second cover part that is set to be fixedly mounted in the vehicle, and a covering structure is fixed using positioning parts (e.g. braid binding, male-female buckle fixing, magic hooks, etc.).

Wherein the other end of the folding and fixing part is in the fix state with the other one of the first cover part and the second cover part when in the tent unfold mode, and the fix state is a direct fixation or detachable fixation.

In details, when in the tent unfold mode, the one end of the folding and fixing part in the separate state from the first cover part or the second cover part is mounted with the positioning parts, such as braids or braids with male-female buckle, at positions corresponding to each corner of the tent, and when in the tent fold mode, the folding and fixing part covers fixedly on the side of the tent through the positioning parts (braid binding etc.).

Further, the folding and fixing part is provided with two or three sets of positioning parts at the positions corresponding to the each corner of the tent, and each set of positioning parts are arranged in parallel.

Alternatively, the folding and fixing part is provided with two sets of positioning parts at the positions corresponding to the each corner of the tent, and the two sets of positioning parts are arranged diagonally and intersectingly.

Alternatively, the positioning parts are divided into first positioning pieces and second positioning pieces; when in the tent unfold mode, the one end of the folding and fixing part in the separate state from the first cover part or the second cover part is mounted with the positioning pieces at an edge, the one of the first cover part and the second cover part that is set to fixedly mounted on the roof of the vehicle is mounted with the second positioning pieces; the one end of the folding and fixing part that is originally in the separate state covers fixedly on the side of tent through a cooperation of the first positioning pieces with the second positioning pieces.

Further, the folding and fixing part is made of tarp, one end of the tarp is provided with a fastening rod, and the fastening rod is matched with a corresponding slot, the fastening rod is detachably fastened and mounted on one of the first cover part and the second cover part that is not fixedly mounted on the roof of the vehicle, and another end of the tarp is mounted with the positioning parts.

In the second aspect:

The one end of the folding and fixing part is in the separate state from the one of the first cover part and the second cover part when in the tent unfold mode, and another end of the folding and fixing part is in a fix state with another one of the first cover part and the second cover part when in the tent unfold mode.

Wherein the fix state is direct fixation or detachable fixation.

In details, the one end of the folding and fixing part in the separate state from the first cover part or the second cover part is provided with an adjustable elastic part when in the tent unfold mode; when in the tent unfold mode, the elastic part is in the separate state from the first cover part or the second cover part; and when in the tent fold mode, the elastic part is fastened to the first cover part or the second cover part, such that the one end of the folding and fixing part that is originally in the separate state fixedly covers on the side of the tent.

Further, the folding and fixing part is made of tarp, one end of the tarp is provided with a fastening rod, and the fastening rod is matched with a corresponding slot, the fastening rod is detachably fastened and mounted on one of the first cover part and the second cover part; another end of the tarp is provided with an elastic part, the elastic part comprises threading holes and a drawstring, and the drawstring runs through the threading holes; a tightness of the elastic part is adjusted by tightening or loosening the drawstring; when in the tent unfold mode, the elastic part of the tarp is loosened to make the tarp in the separate state from the first cover part and the second cover part; and when in the tent fold mode, the elastic part of the tarp is tightened, such that the one end of the folding and fixing part that is originally in the separate state fixedly covers on the side of the tent.

In the third aspect:

Two ends of the folding and fixing part are in the separate state from the first cover part and the second cover part when in the tent unfold mode.

In details, the two ends of the folding and fixing part are provided with adjustable elastic parts; when in the tent unfold mode, the elastic parts are in the separate state from the first cover part and the first cover part; and when in the tent fold mode, the elastic parts are tightened on the first cover part or the second cover part, so that the one end of the folding and fixing part that is originally in the separate state fixedly covers on the side of the tent.

Further, the folding and fixing part is made of tarp, and two ends of the tarp are provided with adjustable elastic parts, and each of the elastic parts comprises threading holes and a drawstring, and the drawstring runs through the threading holes; a tightness of the each of the elastic parts is adjusted by tightening or loosening the drawstring; when in the tent unfold mode, the elastic parts of the two ends of the tarp are loosened to make the two ends of the tarp in the separate state from the first cover part and the second cover part; and when in the tent fold mode, the elastic parts of the two ends of the tarp are tightened, such that the one end of the folding and fixing part that is originally in the separate state fixedly covers on the side of the tent.

After adopting the above solution, the present disclosure has the following advantages compared with the prior art:

1. The folding and fixing part is a whole, instead of the waterproof part in the prior art that two separate members of the first waterproof member and the second waterproof member are used, with fewer components, simplified structure, more convenient processing and assembly, and lower cost;

2. The folding and fixing part has at least one end separated from one of the first cover part and the second cover part in the unfold mode of the tent, while in the tent fold mode, it only the fixedly covers on the side of the first cover part or the second cover part.

The fixed covering manner of the folding and fixing part is different from the waterproof part of U.S. Pat. No. 10,808,416B2 which is completely fixed. Unlike the waterproof part of U.S. Pat. No. 10,808,416B2, the folding and fixing part can completely close the space between the first cover and the second cover in the fold mode. This product can greatly reduce the size requirements of the folding and fixing part, and the folding and fixing part is easier to be flattened on the side covering the first cover part or the second cover part due to the natural sagging effect, and the product has a high yield rate;

3. The folding and fixing part is a whole, no need to increase the fastening line (zipper), the structure is further simplified and the structure is firmer;

4. The folding and fixing part does not require a fastening line (zipper), but the folding and fixing part is directly fastened to the first cover part and/or the second cover part through positioning parts such as braids or elastic parts or a combination thereof. The failure of the fastening line (zipper) can be avoided when in use, the waterproof effect is better, and the maintenance cost can be reduced.

The present disclosure will be described in further detail below with reference to the drawings and specific embodiments.

### BRIEF DESCRIPTION OF DRAWINGS

FIG. 1 is a schematic structural view according to the present disclosure omitting the tent fabric;

FIG. 2 is a schematic structural view according to the present disclosure;

FIG. 3 is a side view according to the present disclosure;

FIG. 4 is a partial enlarged view of FIG. 3;

FIG. 5 is a top perspective view according to the present disclosure in a fold mode;

FIG. 6 is a bottom perspective view according to a first embodiment of the present disclosure in a fold mode;

FIG. 7 is a bottom plan view of according to the first embodiment of the present disclosure in a fold mode;

FIG. 8 is a partial enlarged view of FIG. 7;

FIG. 9 is a side view according to the first embodiment of the present disclosure in a fold mode;

FIG. 10 is a partial enlarged view of FIG. 9;

FIG. 11 is a bottom plan view according to a second embodiment of the present disclosure in a fold mode;

FIG. 12 is a top view of FIG. 11;

FIG. 13 is a bottom plan view according to a third embodiment of the present disclosure in a fold mode;

FIG. 14 is a top view of FIG. 13;

FIG. 15 is a bottom plan view according to a fourth embodiment of the present disclosure in a fold mode;

FIG. 16 is a plan view of FIG. 15.

In the figures:

1—first cover part;

2—second cover part, 21—slot;

3—hinge connection part;

4—folding and fixing part, 41—fastening rod, 42—elastic part, 421—threading hole, 422—drawstring, 423—spring buckle;

5—tent part, 51—tent frame, 52—tent fabric;

6—positioning part, 61—first positioning piece, 62—second positioning piece.

### DESCRIPTION OF EMBODIMENTS

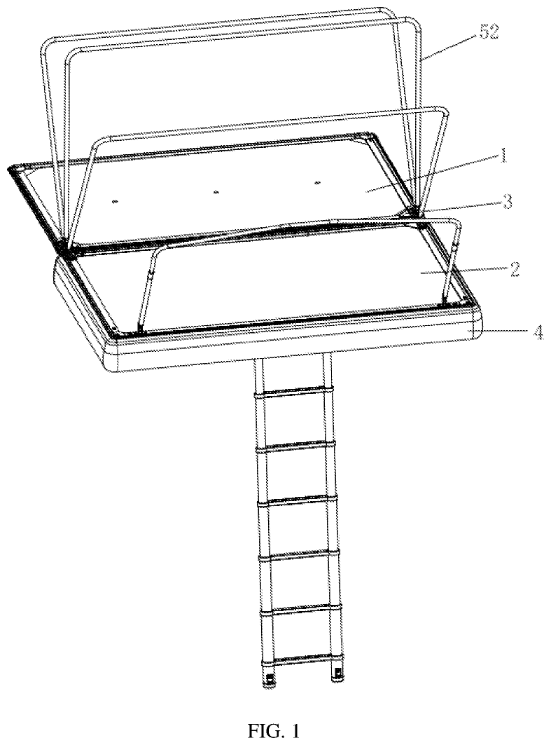

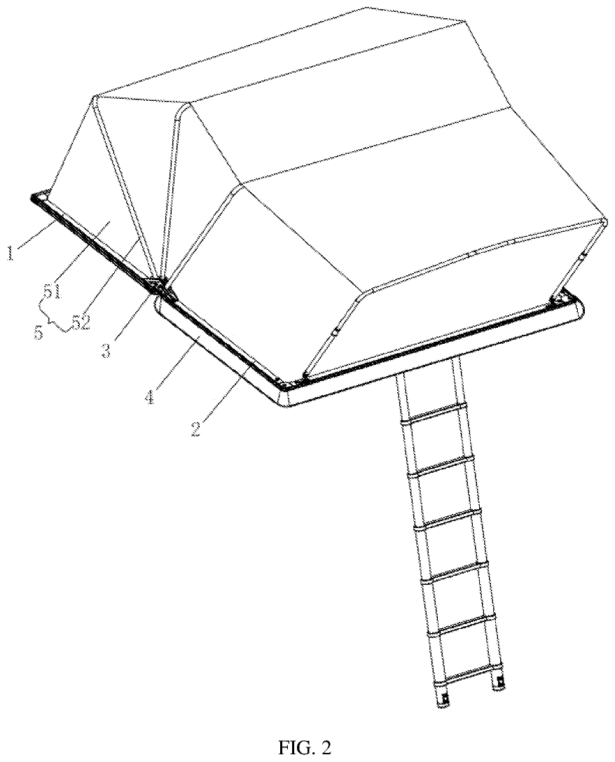

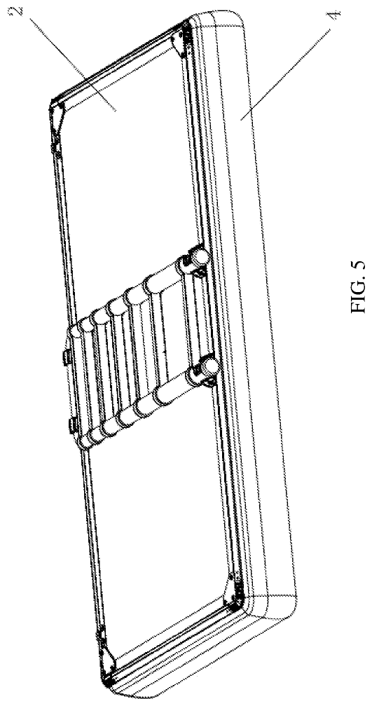

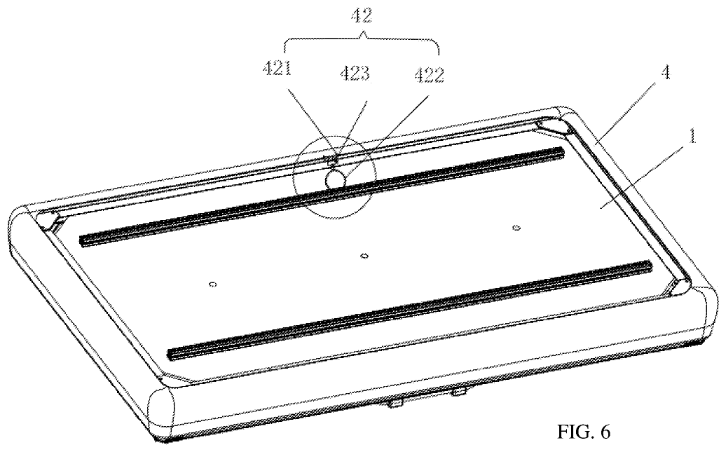

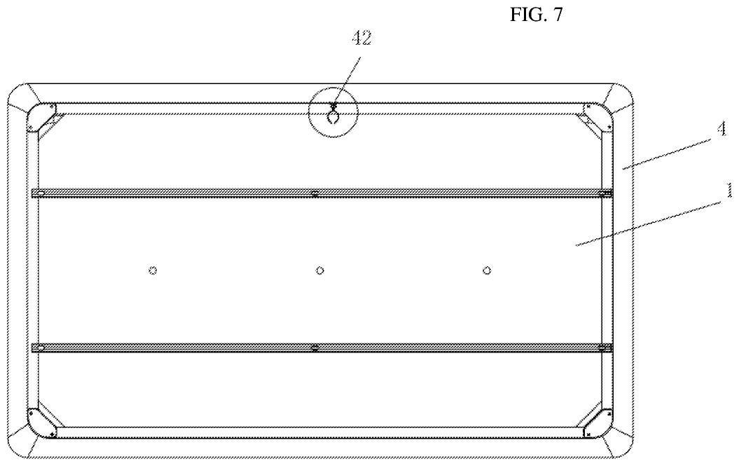

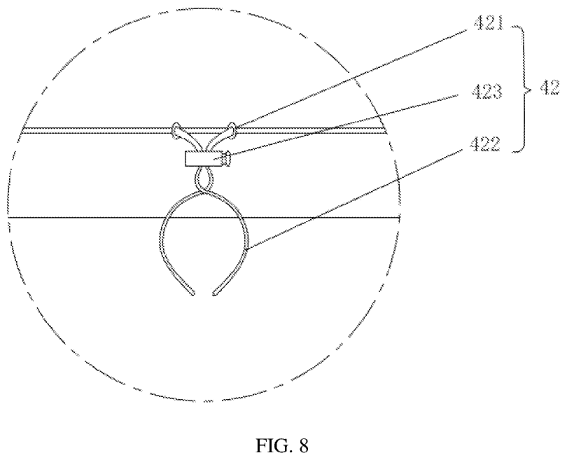

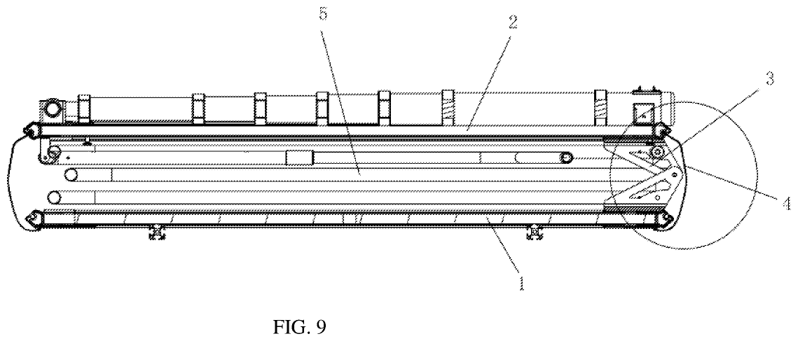

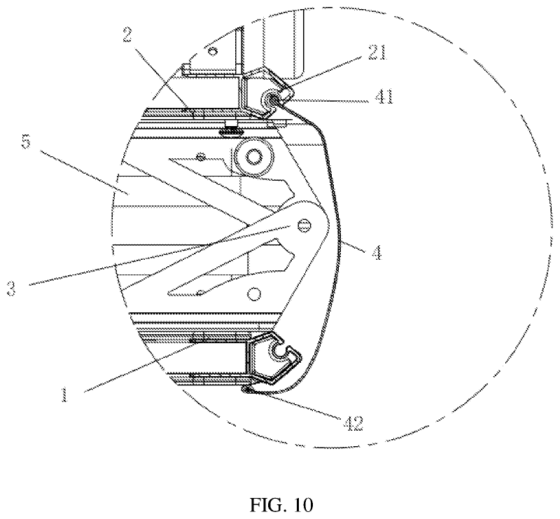

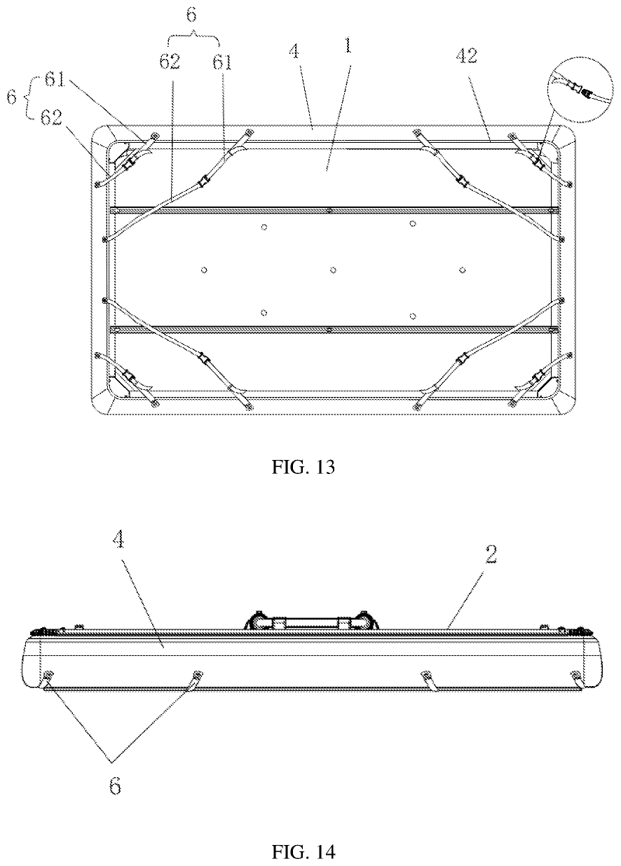

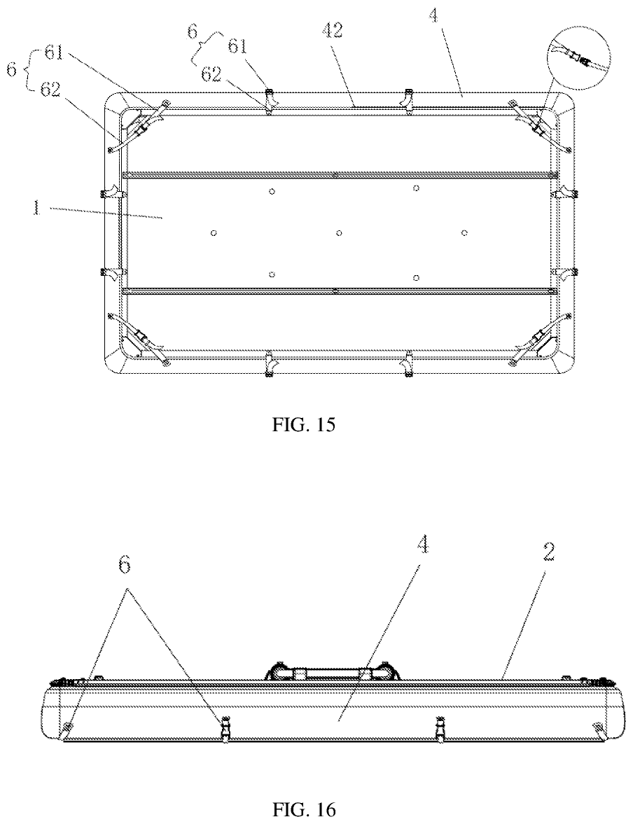

As shown in FIGS. 1 to 16, a rigid roof tent provided in the present disclosure may include: a first cover part 1, a second cover part 2, a hinge connection part 3, a folding and fixing part 4, and a tent part 5.

The hinge connection part 3 may be rotatably connected to the first cover part 1 and the second cover part 2, so that the first cover part 1 and the second cover part 2 can be relatively rotated.

The tent part 5 may include a tent frame 51 and a tent fabric 52. The tent part 5 may be connected to the first cover part 1 and the second cover part 2 to provide space for accommodating people and objects.

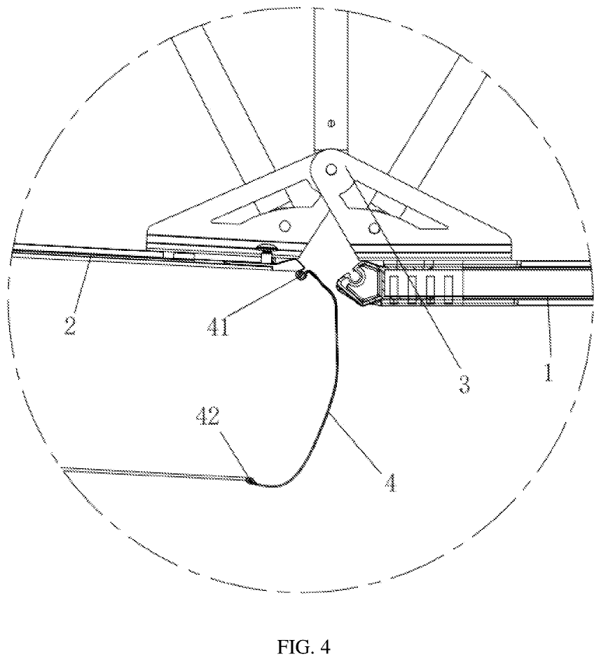

One of the first cover part 1 and the second cover part 2 may be configured to be fixedly mounted on the roof of the vehicle. In the figures, the first cover part 1 is fixedly mounted on the roof of the vehicle. The first cover part 1 and the second cover part 2 may be arranged to face each other in the tent fold mode, as shown in FIGS. 4 to 16.

At least one end of the folding and fixing part 4 is separated from one of the first cover part 1 and the second cover part 2 when in the tent unfold mode, so that the first cover part 1 and the second cover part 2 of the roof tent may be not limited by the folding and fixing part 4, and they can be relatively rotated to unfold. In the tent fold mode, the end of the folding and fixing part 4 that is originally separated can be fixedly covered on the side of the first cover part 1 or the second cover part 2, so that the first cover part 1 and the second cover part 2 can be restricted by the folding and fixing part 4, fixation can be realized when folded. In the structural design of the embodiments shown in the figures, the height dimension of the folding and fixing part 4 may be usually larger than the height of the tent in the tent fold mode, so that the folding and fixing part 4 can completely cover the first cover part 1 and the second cover part 2, for better playing the role of reductions of windproof, waterproof and wind resistance.

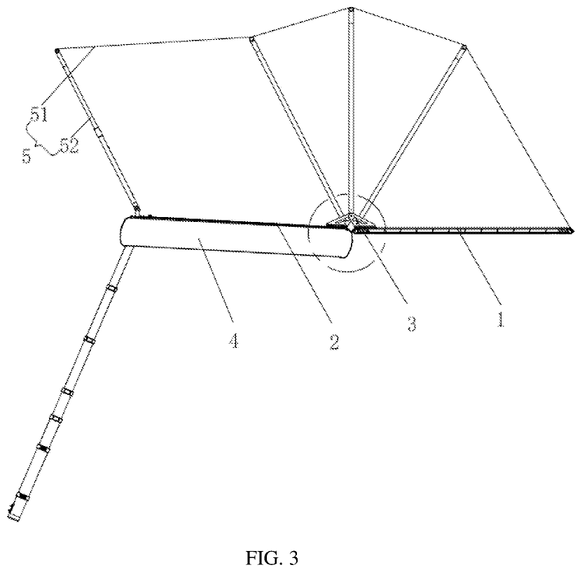

The first embodiment shown in FIGS. 3 to 10 herein is that one end of the folding and fixing part 4 is separated from the first cover part 1 in the tent unfold mode, and the other end of the folding and fixing part 4 is in a fix state with the second cover part 2 in the tent unfold mode. The fix state may be directly fixed, or it may be detachably fixed through the cooperation of the fastening rod 41 with the slot 21 as shown in the figures, and may also be fixed by other methods such as rivet fixation or locking fixation.

Further preferably, when in the tent unfold mode, the one end of the fold and fixing part 4 illustrated herein may have an adjustable elastic part 42 where it is separated from the first cover part 1. In the tent unfold mode, the elastic part 42 and the first cover part 1 are in the separate state, and when in the tent fold mode, the elastic part 42 is tightened on the first cover part 1, so that the end of the folding and fixing part 4 originally in the separate state is fixedly covered on the side of the tent, and the first cover part 1 and the second cover part 2 can be fixed when folded.

Further preferably, the folding and fixing part 4 adopts a tarp (tarpaulin) or a waterproof cloth. One end of the tarp may be provided with a fastening rod 41, the fastening rod 41 is matched with the corresponding slot 21, and the fastening rod 41 is detachably fastened and mounted on the second cover part 2. The other end of the tarp may be provided with an elastic part 42, which includes threading holes 421 and a drawstring 422. The drawstring 422 runs through the threading holes 421, and the tightness of the elastic part 42 can be adjusted by tightening or loosening the drawstring 422. In the tent unfold mode, the elastic part 42 of the tarp is loosened, so that the tarp is separated from the first cover part 1. The first cover part 1 and the second cover part 2 are not restricted by the folding and fixing part 4, and the second cover part 2 can rotate relative to the first cover part 1 to unfold. In the tent fold mode, the elastic part 42 of the tarp is tightened and can be locked with a spring buckle 423, or locked with a tether. The elastic part 42 is tightened on the first cover part 1, so that the fixed part 4 is folded. One end of the folding and fixing part 4 originally in a separate state may cover on the side of the tent, and the first cover part 1 and the second cover part 2 are folded and fixed together under the constraint of the folding and fixing part 4.

Of course, the installation and fixing method of the folding and fixing part 4 can also be opposite to the first embodiment shown in FIGS. 3 to 10. In details, one end of the folding and fixing part 4 may be separated from the second cover part 2 in the tent unfold mode, the other end of the folding and fixing part 4 is in a fix state with the first cover part 1 in the tent unfold mode. The other structure is similar to the illustrated embodiment. In this embodiment, in the tent unfold mode, the elastic part 42 of the tarp may be loosened, so that the tarp is separated from the second cover part 2. The first cover part 1 and the second cover part 2 are not restricted by the folding and fixing part 4. The second cover part 2 can rotate relative to the first cover part 1 to unfold. In the tent fold mode, the elastic part 42 of the tarpaulin may be tightened and can be locked with a spring buckle 423 or locked by a tether. The elastic part 42 is fastened to the second cover part 2, and the first cover part 1 and the second cover part 2 are folded and fixed together under the constraints of the folding and fixing part 4.

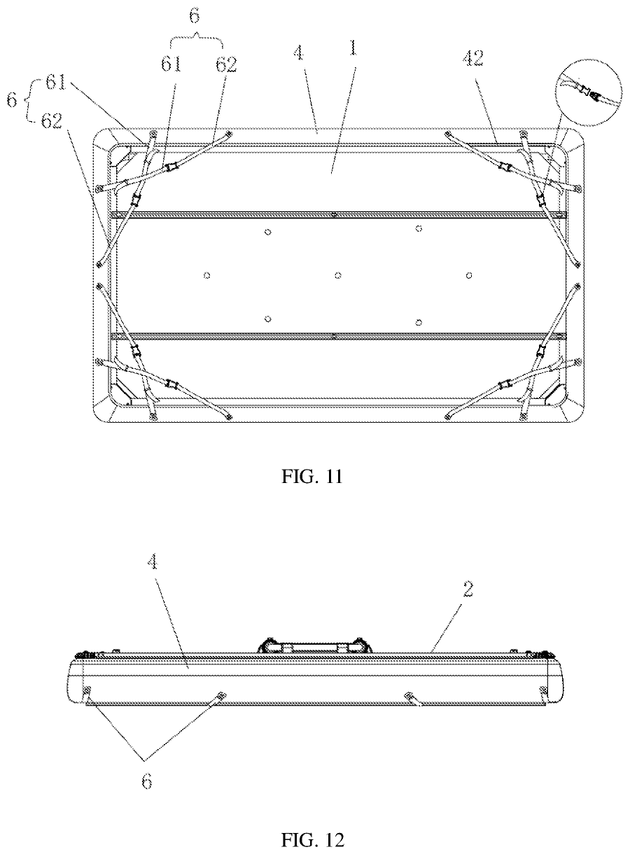

In the second to fourth embodiments shown in FIGS. 11 to 16 herein, one end of the folding and fixing part 4 may be also separated from the first cover part 1 (which is set to be fixedly mounted on the roof of the vehicle) in the tent unfold mode, the other end of the folding and fixing part 4 is in a fix state with the second cover part 2 in the tent unfold mode. In the tent fold mode, the end (the lower end shown in the figures) of the folding and fixing part 4 originally in the separate state is covered on the first cover part 1, and the end of the folding and fixing part 4 is originally in the separate state may be tightened by the positioning parts 6, such that the cover structure can be fixed. The positioning part 6 can be bound by a braid, or fixed with male-female buckles or strong magic hook, etc. As shown in the figures, the positioning parts 6 are fixed by male-female buckles, and are divided into the first positioning pieces 61 and the second positioning pieces 62. The folding and fixing part 4 can also be made of tarp. The structure in the fix state is the same as the embodiment, it can be directly fixed, or can be detachably fixed through the cooperation of the fastening rod with the slot, and can also be fixed by other methods such as rivet fixation or lock fixation.

In the second to fourth embodiments, in the tent unfold mode, the one end of the folding and fixing part 4 that is in the separate state from the first cover part 1 is mounted with positioning parts 6 at positions corresponding to each corner of the tent; and in the tent fold mode, the folding and fixing part 4 is fixedly arranged on the side of the first cover part 1 and the second cover part 2 by the positioning parts 6.

Among them, in the second and third embodiments, the folding and fixing part 4 is mounted with two sets of positioning parts 6 at positions corresponding to each corner of the tent. The two sets of positioning parts 6 in the second embodiment may be arranged diagonally and alternately. The fixing structure is simple, the fixing operation is convenient and the fixing effect is good. The two sets of positioning parts 6 in the third embodiment may be arranged in parallel, and the fixing structure is simple and the effect is good.

In the fourth embodiment, in the tent unfold mode, the one end of the folding and fixing part 4 that is separated from the first cover part 1 may be mounted with the first positioning pieces 61 on the edge, and the second positioning pieces 62 are mounted on the edge of the first cover part 1. Through the cooperation of the first positioning pieces 61 with the second positioning pieces 62, the end of the folding and fixing part 4 originally in the separate state can further fixedly cover on the side of the tent.

It should be noted that not only the elastic part 42 of the first embodiment can be combined with the positioning parts 6 of the second to fourth embodiments, the positioning parts 6 of the second to fourth embodiments can also be combined with each other. In addition, in the first to the fourth embodiments, other equivalent tightening and fixing structures can be added to improve the fixing effect of the folding and fixing part 4.

In the present disclosure, both ends of the folding and fixing part 4 can be separated from the first cover part 1 and the second cover part 2 in the tent unfold mode. Specifically, the two ends of the folding and fixing part 4 may be provided with adjustable elastic parts. The structure of each elastic part can be the same as in the previous embodiment. In the tent unfold mode, the elastic parts are separated from the first cover part 1 and the second cover part 2. In the tent fold mode, the elastic parts are tightened on the first cover part 1 and the second cover part 2, so that one end of the folding and fixing part 4 originally in a separate state is fixedly covered on the side of the tent. Similarly, the folding and fixing part 4 can be a tarp. The two ends of the tarp may have adjustable elastic parts. The elastic part may include threading holes and a drawstring. The drawstring runs through the threading holes.

The drawstring is tightened or loosened so as to adjust the tightness of the elastic part. In the tent unfold mode, the elastic parts of the two ends of the tarp are loosened so that the two ends of the tarp are separated from the first cover part and the second cover part. In the tent fold mode, the elastic parts at both ends of the tarp are tightened, so that one end of the folding and fixing part 4 originally in a separate state is fixedly covered on the side of the tent.

Because the elastic parts are separated from the first cover part 1 and the second cover part 2, so in the tent unfold mode, the folding and fixing part 4 can be completely disassembled and stored aside for later use. Of course, the elastic part at one end can also be tightened, and the elastic part of the end may be fastened to the first cover part 1 or the second cover part 2. The folding and fixing part 4 can be selected according to the situation whether to maintain the connection with the first cover part 1 and the second cover part 2 during use.

The integral folding and fixing part 4 of the present disclosure, compared with the split waterproof part of the prior art (using the first waterproof member and the second waterproof member), may have simple and firm structure, more convenient processing and assembly, and reduced cost. Failure will not appear in use, such that better waterproof effect, reduced maintenance costs can be achieved.

The above are only preferred embodiments of the present disclosure, but the design concept of the present disclosure is not limited to this. Any insubstantial modification of the present disclosure using this concept should be an act that violates the protection scope of the present disclosure.

What is claimed is:

1. A rigid roof tent, comprising: a first cover part, a second cover part, a hinge connection part, a folding and fixing part, and a tent part, wherein:
the hinge connection part is rotatably connected to the first cover part and the second cover part,
the tent part is connected to the first cover part and the second cover part,
one of the first cover part or the second cover part is configured to be fixedly mounted on a roof of a vehicle,
the first cover part and the second cover part are arranged to face each other when in a tent fold mode,
at least one end of the folding and fixing part is in a separate state from the one of the first cover part or the second cover part when in a tent unfold mode, and
the at least one end of the folding and fixing part that is in the separate state from the one of the first cover part or the second cover part when in the tent unfold mode covering fixedly on a side of the one of the first cover part or the second cover part when in the tent fold mode, so that the first cover part and the second cover part are fixed when the first cover part and the second cover part are folded.

2. The rigid roof tent according to claim 1, wherein:
the at least one end of the folding and fixing part is in the separate state from the one of the first cover part or the second cover part that is set to be fixedly mounted in the vehicle when in the tent unfold mode,
another end of the folding and fixing part is in a fixed state with another one of the first cover part or the second cover part when in the tent unfold mode,
when in the tent fold mode, the at least one end of the folding and fixing part that is in the separate state from the one of the first cover part or the second cover part when in the tent fold mode covers the one of the first cover part or the second cover part that is set to be fixedly mounted in the vehicle, and
a covering structure is fixed using positioning parts.

3. The rigid roof tent according to claim 2, wherein the fixed state is a direct fixation or detachable fixation.

4. The rigid roof tent according to claim 2, wherein:
when in the tent unfold mode, the at least one end of the folding and fixing part in the separate state from the one of the first cover part or the second cover part is mounted with the positioning parts at positions corresponding to each corner of the rigid roof tent, and
when in the tent fold mode, the folding and fixing part covers fixedly on a side of the rigid roof tent through the positioning parts.

5. The rigid roof tent according to claim 4, wherein:
the folding and fixing part is provided with two or three sets of positioning parts at the positions corresponding to the each corner of the rigid roof tent, and
each of the two or three sets of positioning parts are arranged in parallel.

6. The rigid roof tent according to claim 4, wherein:
the folding and fixing part is provided with two sets of positioning parts at the positions corresponding to the each corner of the rigid roof tent, and
the two sets of positioning parts are arranged diagonally and intersectingly.

7. The rigid roof tent according to claim 4, wherein:
the positioning parts are divided into first positioning pieces and second positioning pieces,
when in the tent unfold mode, the at least one end of the folding and fixing part that is in the separate state from the one of the first cover part or the second cover part is mounted with the first positioning pieces at an edge and the one of the first cover part or the second cover part that is set to fixedly mounted on the roof of the vehicle is mounted with the second positioning pieces, and
the at least one end of the folding and fixing part that is in the separate state from the one of the first cover part or the second cover part when in the tent unfold mode covers fixedly on the side of rigid roof tent through a cooperation of the first positioning pieces with the second positioning pieces.

8. The rigid roof tent according to claim 2, wherein:
the folding and fixing part is made of a tarp,
one end of the tarp is provided with a fastening rod,
the fastening rod is matched with a corresponding slot,
the fastening rod is detachably fastened and mounted on one of the first cover part or the second cover part that is not fixedly mounted on the roof of the vehicle, and
another end of the tarp is mounted with the positioning parts.

9. The rigid roof tent according to claim 1, wherein:
another end of the folding and fixing part is in a fixed state with another one of the first cover part or the second cover part when in the tent unfold mode.

10. The rigid roof tent according to claim 9, wherein the fixed state is direct fixation or detachable fixation.

11. The rigid roof tent according to claim 9, wherein:
the at least one end of the folding and fixing part in the separate state from the one of the first cover part or the second cover part is provided with an adjustable elastic part when in the tent unfold mode,
when in the tent unfold mode, the adjustable elastic part is in the separate state from the one of the first cover part or the second cover part, and
when in the tent fold mode, the adjustable elastic part is fastened to the one of the first cover part or the second cover part, such that the at least one end of the folding and fixing part in the separate state from the one of the first cover part or the second cover part when in the tent unfold mode fixedly covers the side of the rigid roof tent.

12. The rigid roof tent according to claim 9, wherein:
the folding and fixing part is made of a tarp,
one end of the tarp is provided with a fastening rod,
the fastening rod is matched with a corresponding slot,
the fastening rod is detachably fastened and mounted on one of the first cover part or the second cover part,
another end of the tarp is provided with an elastic part,
the elastic part comprises threading holes and a drawstring,
the drawstring runs through the threading holes,
a tightness of the elastic part is adjusted by tightening or loosening the drawstring,
when in the tent unfold mode, the elastic part of the tarp is loosened to make the tarp be in the separate state from the one of the first cover part or the second cover part, and
when in the tent fold mode, the elastic part of the tarp is tightened, such that the at least one end of the folding and fixing part that is in the separate state from the one of the first cover part or the second cover part when in the tent unfold mode fixedly covers a side of the rigid roof tent.

13. The rigid roof tent according to claim 1, wherein two ends of the folding and fixing part are in the separate state from the one of the first cover part or the second cover part when in the tent unfold mode.

14. The rigid roof tent according to claim 13, wherein:
the two ends of the folding and fixing part are provided with adjustable elastic parts,
when in the tent unfold mode, the adjustable elastic parts are in the separate state from the first cover part and the first cover part,
when in the tent fold mode, the adjustable elastic parts are tightened on the first cover part or the second cover part, so that the one end of the folding and fixing part that is in the separate state from the one of the first cover part or the second cover part when in the tent unfold mode fixedly covers a side of the rigid roof tent.

15. The rigid roof tent according to claim 13, wherein:
the folding and fixing part is made of a tarp,
two ends of the tarp are provided with adjustable elastic parts,
each of the adjustable elastic parts comprises threading holes and a drawstring,
the drawstring runs through the threading holes,
a tightness of the each of the adjustable elastic parts is adjusted by tightening or loosening the drawstring,
when in the tent unfold mode, the adjustable elastic parts of the two ends of the tarp are loosened to make the two ends of the tarp be in the separate state from the first cover part and the second cover part, and
when in the tent fold mode, the adjustable elastic parts of the two ends of the tarp are tightened, such that the at least one end of the folding and fixing part that is in the separate state from the one of the first cover part or the second cover part when in the tent unfold mode fixedly covers a side of the rigid roof tent.
